(19) United States
(12) Patent Application Publication
(10) Pub. No.: US 2013/0188043 A1
(43) Pub. Date: Jul. 25, 2013

(54) Active illumination scanning imager

(71) Applicant: Yves Decoster, Ethe (Virton) (BE)

(72) Inventor: Yves Decoster, Ethe (Virton) (BE)

(73) Assignee: IEE INTERNATIONAL ELECTRONICS & ENGINEERING S.A., Luxembourg (LU)

(21) Appl. No.: 13/812,926

(22) PCT Filed: Jul. 19, 2011
(86) PCT No.: PCT/EP2011/062314

§ 371 Date: Apr. 1, 2013

(30) Foreign Application Priority Data
Jul. 29, 2010 (LU) 91 714

(51) Int. Cl. G01B 11/24

(52) U.S. Cl. CPC G01B 11/24
USPC 348/135

(57) ABSTRACT

An active-illumination scanning imager (10) comprises a light source (14) for producing a light beam (16), an optical collimator (18) for collimating the light beam, a scanning mirror (20) for scanning the light beam through a scene (12) to be imaged, and a light detector (22) arranged with respect to the scanning mirror in such a way as to receive a fraction (24) of said light beam reflected from said scene, via the scanning mirror. The imager further includes an actuator (40) configured to position the light source and/or the optical collimator relative to each other and/or the light detector relative to the scanning mirror, and a controller (46) operatively connected to the actuator for controlling the positioning.

### TECHNICAL FIELD

The present invention generally relates to an active-illumination scanning imager, i.e. a scanning imager that illuminates the scene to be imaged, in particular such an scanning imager that comprises an oscillating scanning mirror to scan a light beam though the scene to be imaged.

### BACKGROUND ART

EP 1 289 273 discloses a scanning camera equipped with a micromechanical mirror that oscillates about two mutually perpendicular axes to scan an object. The scene is imaged in time-division multiplexed manner onto a punctiform optoelectronic sensor. The scanning camera, however, does not illuminate the scene actively.

Imagers with active scene illumination are used, for instance, for recording range images based on the time-of-flight measurement principle. In the context of the present document, a “range image” is an image composed of pixels, each of which contains a distance value representing the distance from the imager to the point in the scene with which the pixel is associated.

Systems for creating such 3-D representations of a scene have a variety of applications in many different technology fields. Examples are automotive sensor technology (e.g. vehicle occupant detection and classification), robotic sensor technology (e.g. object identification) or safety engineering (e.g. plant monitoring, people counting and pedestrian detection) to name only a few. As opposed to conventional 2-D imaging, a 3-D imaging system requires depth information about the target scene. In other words, the distances between one or more observed objects and an optical receiver of the system need to be determined. A well-known approach for distance measurement, which is used e.g. in radar applications, consists in timing the interval between emission and echo-return of a measurement signal. This so called time-of-flight (TOF) approach is based on the principle that, for a signal with known propagation speed in a given medium, the distance to be measured is given by the product of the propagation speed and half the time the signal spends to travel back and forth. In case of optical imaging systems, the measurement signals are light waves. For the purposes of the present description, the term “light” is to be understood as including visible, infrared (IR) and ultraviolet (UV) light.

Another possible application of an active-illumination scanning imager is gas sensing. A map of gas distribution may be obtained by scanning a scene with a laser beam of a wavelength corresponding to an absorption line of the target gas and measuring the absorption of the laser light in each part of the scene.

With scanning imagers that scan a light beam through the scene under observation, the quality of the image depends to some extent on beam divergence. Each pixel of the image to be computed corresponds to a solid angle element along a particular direction of the scanning light beam. Most accurate images are normally obtained when the illuminating light beam approximately matches with the solid angle elements in terms of shape and divergence. If the illuminating light beam is too narrow, the properties of one sample of reflected and detected light will not necessarily be representative for the entire solid angle element (or the pixel). If the illuminating light beam is too broad, the image will suffer from poor contrast due to averaging between neighboring pixels.

Active-illumination laser imagers typically use a laser diode as the light source. The beam produced by laser diodes diverges rapidly when coupled out of the semiconductor chip. This means that a special optic with a small focal length (typically a few millimeters, e.g. 1 to 10 mm) has to be placed in front of the laser diode to achieve low beam divergence (typically less than 1°, e.g. about 0.2°, but higher divergence may be tolerated if lower image resolution is acceptable). Due to the small focal length, very careful alignment of the laser diode and the optical system is necessary to obtain a collimated beam that propagates along the desired direction.

### BRIEF SUMMARY

The invention facilitates collimation of a light beam used for active illumination of a scene to be imaged.

An active-illumination scanning imager comprises a light source (e.g. a laser diode) for producing a light beam, an optical collimator (e.g. a collimating lens or mirror) for collimating the light beam in at least one direction transversal to the beam direction, a scanning mirror for scanning the light beam through a scene to be imaged, and a light detector arranged with respect to the scanning mirror in such a way as to receive a fraction of the light beam reflected from the scene via the scanning mirror. According to the invention, the active illumination scanning imager includes an actuator (e.g. an automated tip/tilt stage, an automated linear actuator, an automated XY or XYZ-stage, a piezoelectric actuator, etc.) configured to position the light source and/or the optical collimator relative to each other, and/or the light detector relative to the scanning mirror, and a controller operatively connected to the actuator for controlling the positioning.

Those skilled will appreciate that the invention is especially suited for active-illumination imagers, wherein a laser diode serves as the light source. As indicated above, the collimator in this case has to have a relatively small focal length, making careful alignment necessary. Beam divergence is indeed highly dependent on the precise position of the collimator relative to the laser diode. Due to system ageing, misalignment of the optical system could occur, leading to beam defocusing. Thanks to the actuator, which may be arranged to position the light source or the collimator or both, precise alignment or re-alignment of the system may be achieved easily.

It should be noted that the beam could be collimated in one transversal direction of the beam only. For instance, the light source and the collimator could be configured to emit a fan-shaped (pulsed or continuous-wave) light beam with linear cross section. In this case, the scanning mirror is preferably arranged in the light path of the light beam to guide the light beam into the scene and to successively illuminate slices of the scene by sweeping the light beam through the scene transversally to the linear cross section. In this embodiment of the invention, the light detector is preferably part of an imager chip with a linear photosensor array disposed in such a way that the illuminated slices of the scene are successively imaged thereon. The actuator is then preferably controlled by the controller and arranged so as to maintain the alignment and the overlap of the images of the illuminated slices of the scene and the linear photosensor array. In other words, the actuator modifies the position of the light detector, the collimator and/or the light source in such a way that the illuminated slices of the scene are imaged (e.g. via a cylindrical lens or a curved mirror) on the linear photosensor array.

The controller preferably comprises an interface for operatively connecting the imager to a sensor (e.g. a beam profiler) and is preferably configured to attempt to achieve a predefined sensor response through controlling the positioning. Such configuration of the controller is especially advantageous for aligning the light source and the collimator after the imager has been assembled. Slight misalignment of the light source and the collimator could thus be tolerated during the assembly. After the assembly, the imager may be mounted on a test bench equipped with a beam profiler (such as e.g. a CCD or CMOS camera without focusing optics). The beam profiler is preferably connected to the controller via the interface and the controller is most preferably configured to execute an alignment procedure during which the beam profile is optimized under standardized conditions.

During operation of the imager, the light detector (photodetector) may acquire samples of the light reflected from the scene in a time-division multiplexed manner. The position of the scanning mirror being known for each sample, each sample can be associated to the corresponding pixel (image element) and the image can be computed.

The light detector may be operatively connected to the controller, which is then advantageously configured to control the positioning of the light source and the collimator relative to each other in response to a detection signal from the detector. The controller could e.g. be configured to optimize one or more parameters (e.g. the signal-to-noise ratio) of the detection signal. The light detector could e.g. be or comprise a position sensing photodetector (commonly referred to as PSD), e.g. a segmented PSD (in particular a two- or a four-quadrant PSD), a lateral-effect PSD (in particular a duo- or tetra-lateral PSD). If a position sensing photodetector is used, the position signal of that detector may be used by the controller to achieve the positioning.

Preferably, the scanning mirror comprises a resonance-type micro-mechanical mirror.

The imager may e.g. be a time-of-flight scanning imager. In this case, the light beam emitted into the scene is modulated in intensity and the light detector is advantageously a lock-in photodetector, i.e. a photodetector clocked in synchronism with the modulation of the emitted light for modulation-phase sensitive detection of the reflected light. Examples of lock-in photodetectors can e.g. be found in R. Lange's doctoral thesis “3D Time-of-Flight Distance Measurement with Custom Solid-State Image Sensors in CMOS/CCD-Technology” (2000, University of Siegen) or in T. Spirig's doctoral thesis “Smart CCD/CMOS Based Image Sensors with Programmable, Real-Time, Temporal and Spatial Convolution Capabilities for Applications in Machine Vision and Optical Metrology” (1997, Swiss Federal Institute of Technology, Diss. ETH No. 11993). Alternatively, in case of a pulsed light source, the light detector could be a photodiode associated with a time-to-digital converter (TDC).

The actuator is preferably configured and arranged to change an optical path length between the light source and the optical collimator. The actuator may e.g. be configured to move the light source relative to the optical collimator along the optical axis of the collimator. Such movement may be used to adjust the divergence of the emitted light beam. Additionally or alternatively, the actuator may be configured and arranged to move the light source and or the optical collimator transversally to the optical path. As a further option, the actuator may be configured and arranged to tilt the light source and/or the optical collimator relative to one another. Finally, the actuator may be configured and arranged to displace and/or to tilt the light detector.

### BRIEF DESCRIPTION OF THE DRAWINGS

A preferred embodiment of the invention will now be described, by way of example, with reference to the accompanying drawings in which:

FIG. 1 is a schematic layout of an active-illumination scanning imager for recording range images of a scene;

FIG. 2 is an illustration of how the position of the light source influences on beam divergence;

FIG. 3 is an illustration of the alignment procedure carried out after assembly of the scanning imager;

FIG. 4 is an illustration of a resonance-type micro-electromechanical mirror;

FIG. 5 is a schematic layout of an embodiment of the invention with a position sensitive photodetector;

FIG. 6 is a schematic layout of a preferred variant of the active-illumination scanning imager of FIG. 1;

FIG. 7 is a schematic layout of an active-illumination scanning imager, which emits a fan-shaped beam into the scene;

FIG. 8 is a schematic view of an imager chip for a scanning imager as in FIG. 7.

### DETAILED DESCRIPTION

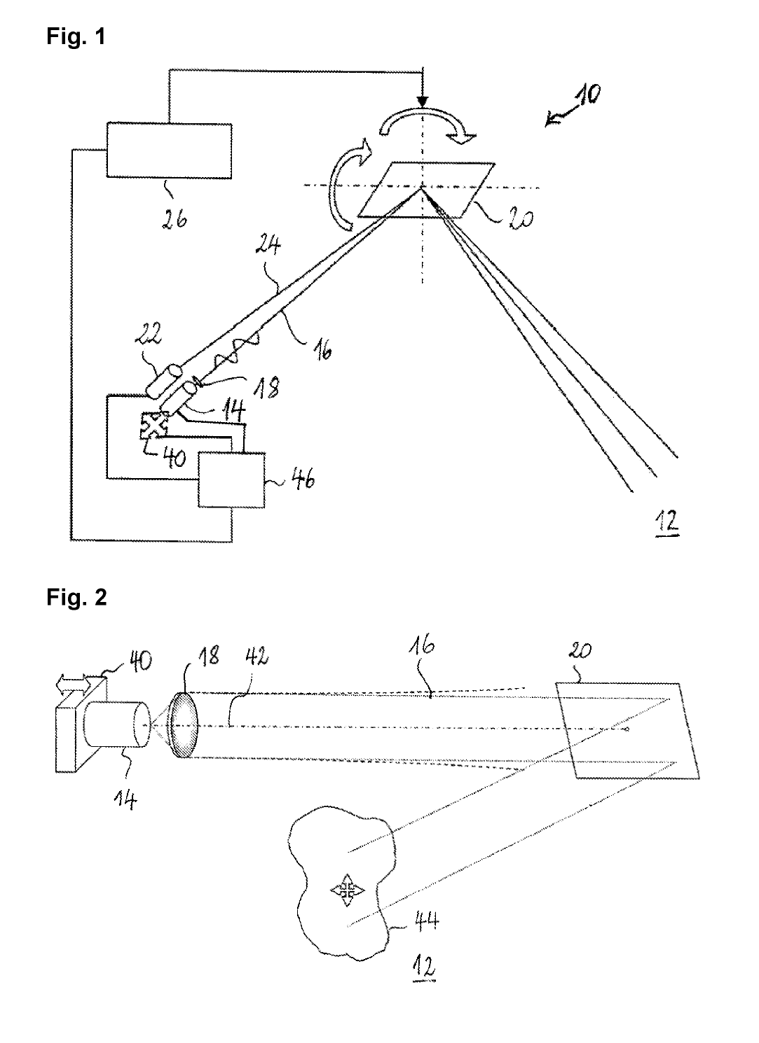

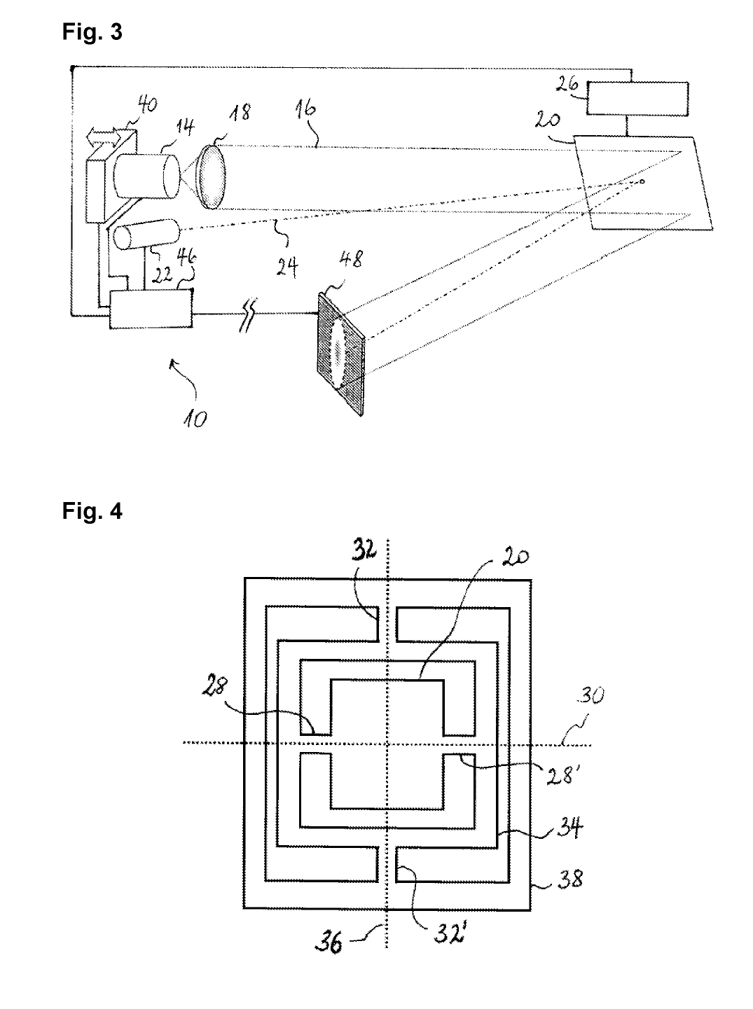

FIG. 1 schematically shows an active-illumination scanning imager 10 according to a preferred embodiment of the invention. The active-illumination scanning imager 10 is configured for producing a range image of the scene 12 under observation. It comprises a laser diode 14 for producing a pulsed laser beam 16, an optical collimator 18 (here a collimating lens) for collimating the laser beam 16, a scanning mirror 20 for scanning the laser beam 16 through the scene 12, and a photodetector 22 (e.g. a single photon avalanche diode) for detecting a fraction of the light 24 that is reflected from the scene 12, via the scanning mirror 20. The photodetector 24 is equipped with a time-to-digital converter (TDC, not shown) that measures the duration between a reference point in time (the time of emission of a laser pulse) and the instant when the return pulse from the scene 12 hits the photodetector 24. The time interval between emission and reception of the laser pulse corresponds to twice the distance between the scanning imager 10 and the point in the scene 12 hit by the laser pulse.

The scanning mirror 20 is a resonance-type micro-mechanical mirror, which is shown in more detail in FIG. 4. It is mounted on first torsion bars 28, 28′, which define a first tilting axis 30. The first torsion bars 28, 28′ connect the micromechanical mirror to an intermediate frame 34, which is itself mounted on second torsion bars 32, 32′. The second torsion bars 32, 32′define a second tilting axis 36, which is orthogonal to the first tilting axis 30. The second torsion bars 32, 32′ connect the intermediate frame 34 to an outer frame 38. The micro-mechanical mirror 20, the intermediate and outer frames 34, 38 and the torsion bars 28, 28′, 32, 32′ are preferably integrally formed from the same substrate. The scanning mirror also comprises an actuator (not shown) to make the mirror 20 oscillate about the first and second tilting axes 30, 36, respectively. The actuator and the micromechanical mirror 20 comprise electromagnetic elements (e.g. coils or conductor loops, or capacitor plates) and possibly also permanent-magnetic elements to transmit forces and torques between the actuator and the micromechanical mirror 20, causing the latter to leave the position in which the sum of mechanical forces (here: the torsion forces of the torsion bars 28, 28′, 32, 32′) acting thereon cancels (equilibrium position). In operation, the mirror driver 26 (see. FIG. 1) applies oscillating signals to the electromagnetic elements, which create periodically inverting electric and/or magnetic forces and torques that act on the micromechanical mirror 20 and cause it to tilt to and fro about the first axis 30. Simultaneously, the intermediate frame is caused to tilt to and fro about the second axis 36 under the action of the electric and/or magnetic forces and torques. As a result, the micromechanical mirror 20 carries out a movement in two dimensions corresponding to the superposition of the two simple oscillatory movements and the laser beam 16 that is deviated by the micromechanical mirror describes a Lissajou curve in the scene to be imaged 12. The mirror driver 26 is configured to drive both movements at or close to their respective resonance frequency in order to achieve optimal excursion of the micromechanical mirror 20 in both directions with low power consumption. More details about scanning devices of the discussed type can be found e.g. in U.S. Pat. Nos. 7,012,737 and 5,912,608, incorporated herein by reference in their entirety with effect for the jurisdictions in which such incorporation by reference is permitted. Two-dimensional scanning devices are e.g. available from Nippon Signal under the trade name Eco Scan.

The collimator 18 is arranged relative to the laser diode in such a way as to obtain a collimated laser beam at the output of the collimator 18. As the laser beam generated by the laser diode 14 is highly diverging, the collimator 18 is chosen with a short focal length. Consequently, positioning of the collimator 18 and the laser diode 14 relative to each other is critical. The active-illumination scanning imager 10 comprises an actuator 40 (schematically represented in FIG. 1 as a cross of arrows) to modify the position of the laser diode 14 relative to the collimator 18. In the embodiment represented in the figures, the laser diode 14 is mounted on the actuator 40. (Alternatively, the collimator 18 could be mounted on an actuator 40). The actuator 40 could e.g. comprise one or more piezo-electric elements to change the position of the laser diode 14 on the optical axis 42 and/or transversally to the optical axis 42, and/or the orientation thereof (tip/tilt with respect to the optical axis). As illustrated in FIG. 2, adjustment of the laser diode position on the optical axis (i.e. of the distance between the laser diode 14 and the collimator 18) leads to a modification of beam divergence, and thus of the spot size on a surface 44 in the scene 12. (In FIG. 2, only part of the active-illumination scanning imager 10 is represented.)

The laser diode 14, the photodetector 22, the actuator 40 and the scanning mirror driver 26 are controlled by a microcontroller 46 (implemented e.g. as a microprocessor, a field-programmable gate array—FPGA—, an application-specific integrated circuit, or the like). The microcontroller 46 comprises an interface for connecting it to an external beam profiler 48 (e.g. a CCD or CMOS camera without focusing optics). Such beam profiler 48 is used on a test bench on which the active-illumination scanning imager 10 is temporarily mounted after its assembly. The microcontroller 46 is configured to carry out an alignment procedure when connected to the external beam profiler 48. During the alignment procedure, the microcontroller 46 adjusts the position of the laser diode 14 relative to the collimator 18 until the parameters of the beam profile (such as e.g. position of beam center, beam widths) are in agreement with target parameter values. During the alignment procedure, the scanning mirror 26 is kept in its rest position until the alignment of the collimator 18 and the laser diode 14 has been completed.

In the illustrated embodiment of the invention, the microcontroller 46 is furthermore configured to adjust beam divergence in real time when the active-illumination scanning imager 10 is operating. The microcontroller 46 controls the actuator depending on the detection signal received from the photodetector 22, e.g. in such a way as to optimize the signal-to-noise ratio. Those skilled will appreciate that such real-time correction of the laser diode 14 position also compensates for ageing effects on the alignment of the laser diode 14 and the collimator 18. It should be noted that in lieu of using a real-time alignment procedure, the microcontroller 46 could be configured to perform a re-alignment at each start-up of the active-illumination scanning imager 10, before the actual imaging procedure is carried out.

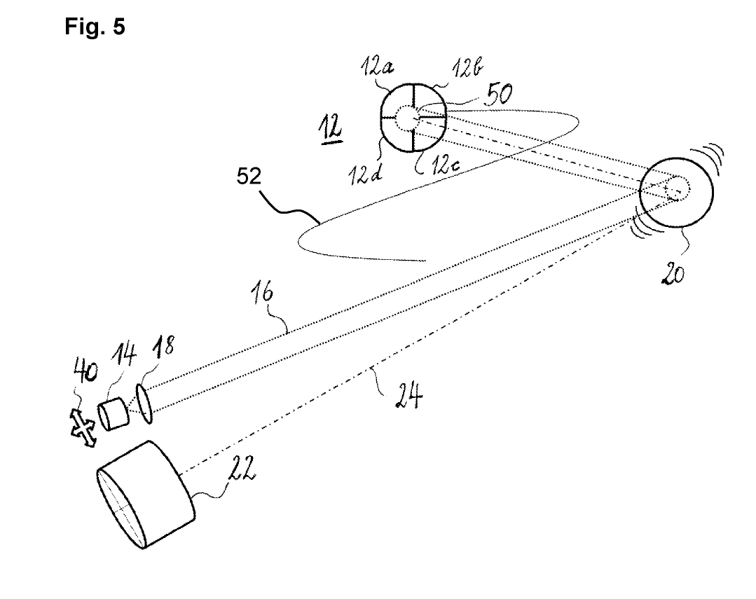

In the embodiments of FIGS. 5-8, the same reference numbers have been kept for the same or similar elements. Referring to FIG. 5, the photodetector 22 is a four-quadrant position-sensitive photodetector. Each of the four quadrants “sees” a different area 12a, 12b, 12c, 12d of the scene 12, via the scanning mirror 20. If the laser spot 50 is well centered, each quadrant of the photodetector 22 generates the same photosignal. If the laser spot 50 is misaligned (e.g. because of a displacement of the optical collimator 18 with respect to the laser diode 14), there will be an imbalance between the photosignals. The microcontroller (not represented in FIG. 5) controls the actuator 40 in such a way as to re-establish balanced signals. That correction may be made in real-time. Reference number 52 indicates the path of the laser spot 50 in the scene 12. The laser spot describes a Lissajou curve.

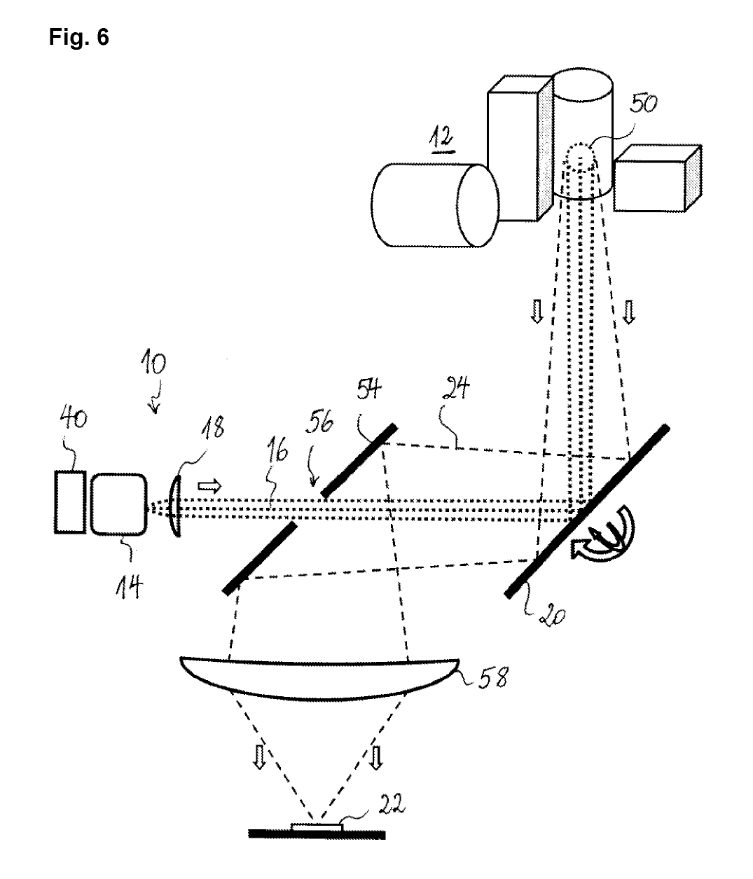

FIG. 6 schematically shows a variant of the active-illumination scanning imager of FIG. 1. The variant of FIG. 6 differs from the active-illumination scanning imager of FIG. 1 in that between the laser diode 14 and the scanning mirror 20, the pulsed laser beam 16 passes through an opening 56 arranged in a static deflection mirror 54, which directs light that is reflected or scattered back from the scene 12 onto the photodetector 22 (e.g. a four-quadrant photodetector). Whereas in the scanning imager of FIG. 1, the photodetector sees the scene from a slightly different angle than the light source, in the scanning imager of FIG. 6, the emitted laser beam 16 and the rays of the reflected light fraction 24 are substantially collinear (but of opposite sense). After deflection at the static deflection mirror 54, the reflected light is focused on the photodetector 22 by means of a focusing lens 58. It should be noted that the deflection mirror 54 could be a focusing mirror, in which case the focusing lens 58 could be omitted.

In the variant of FIG. 6, the laser diode 14 and the collimating lens 18 generate a collimated laser beam of substantially circular cross section, which illuminates a punctiform spot 50 in the scene. The scanning mirror 20 is configured as a “2D”-scanning mirror, i.e. a scanning mirror having two mutually substantially perpendicular pivot axes, in order to move the laser spot 50 along a two-dimensional scanning curve.

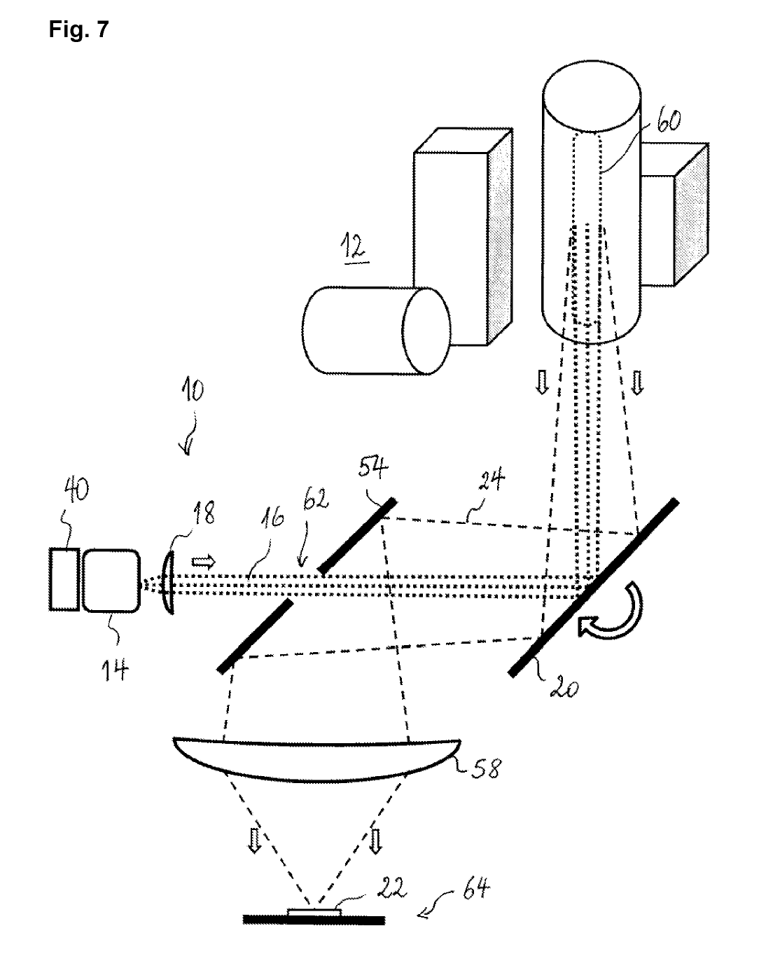

FIG. 7 shows an active-illumination scanning imager, wherein the laser beam generated by the laser diode 14 is fanned out in one transversal direction and collimated in the other transversal direction (at 90° to the first transversal direction), using an astigmatic lens as the optical collimator 18. The laser beam 16 is directed into the scene 12 to be imaged via the scanning mirror 20 arranged in the light path of the laser beam 16. The laser beam 16 thus successively illuminates slices 60 of the scene 12. The scanning mirror 20 is in this embodiment a “1D” scanning mirror, i.e. a scanning mirror having a single pivot axis, which sweeps the fan-shaped laser beam 16 through the scene 12, transversally to the plane in which the laser beam is fanned out. In FIG. 7, the laser beam 16 is fanned out in a plane perpendicular to the plane of the drawing sheet. Between the (one-directional) optical collimator 18 and the scanning mirror 20, the laser beam 16 passes through a slit 62 arranged in the static deflection mirror 54. The latter directs light that is reflected back from the scene 12 onto an imager chip 64 that comprises a linear array of photodetectors 22. A cylindrical (or, more generally, an astigmatic) focusing lens 58 is arranged in the optical path of the reflected light to image the illuminated slices 60 of the scene onto the linear array of photodetectors 22.

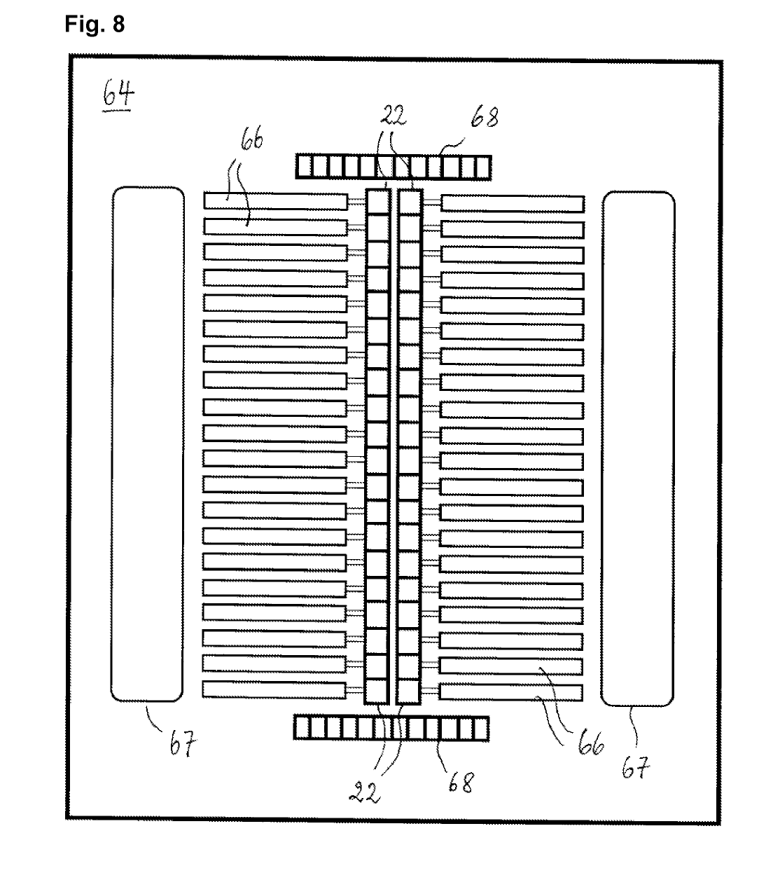

FIG. 8 schematically shows the imager chip 64 of the scanning imager of FIG. 7. The individual photodetectors 22 are disposed in two parallel lines to form an essentially one-dimensional photosensor array. Each photodetector 22 is operatively connected to its specific circuit 66 (e.g. a TDC). Timing and read-out circuits 67 are provided to control and synchronize operation of the photodetectors 22, and to read out the different measurement values.

Each photodetector 22 and its associated circuits 66, 67 measure the duration between a reference point in time (the time of emission of a laser pulse) and the instant when the return pulse from the scene hits the photodetector 22.

The photodetectors 22 are preferably SPADs (Single Photon Avalanche Diodes). Advantageously, the photodetector array of FIG. 8 comprises more than 1000 individual photodetectors 22 per line. Resolutions in the mega-pixel range thus become feasible also with ToF imagers.

As in the previously discussed embodiments of the invention, the actuator 40 is configured and arranged to maintain the alignment of the laser beam 16 with the desired optical axis. The actuator is controlled by a controller (not shown in FIGS. 7 and 8), which is responsive to measurements made by the imager chip 64. The imager chip 64 comprises dedicated beam position detectors 68 arranged at either end of the array of photodetectors 22. With the beam position detectors 68, one measures the lateral offset of the reflected light beam with respect to the photodetector array and the angle between the major axis of the reflected light beam and the photodetector array. The controller uses these measurements to control the actuator in such a way that the lateral offset and the angle are minimized. It may be worthwhile noting that the lateral offset and the angle could also be minimized based on the signals of the individual photodetectors 22, because in case of optimal alignment, the photosignals of each pair of (a left and a right) photodetectors 22 are balanced. Accordingly, separate beam position detectors 68 as illustrated in FIG. 8 may be considered optional.

It should be noted that, instead of a deflection mirror 54 with a punctiform or elongated opening, one could use a beam splitter to direct the reflected light fraction to the photodetector(s).

While specific embodiments have been described in detail, those skilled in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

1. Active-illumination scanning imager, comprising a light source for producing a light beam, an optical collimator for collimating said light beam in at least one direction transversal to a beam direction, a scanning mirror for scanning said light beam through a scene to be imaged and a light detector arranged with respect to said scanning mirror in such a way as to receive a fraction of said light beam reflected from said scene, via said scanning mirror;
wherein said imager further comprises an actuator configured to position at least one of said light source and/or said optical collimator relative to one another and/or to position said light detector relative to said scanning mirror, and a controller operatively connected to said actuator for controlling said positioning.

2. The imager as claimed in claim 1, wherein said controller comprises an interface for operatively connecting said scanner to a sensor, said controller being configured to attempt to achieve a predefined sensor response through controlling said positioning.

3. The imager as claimed in claim 1, wherein said light detector is operatively connected to said controller and wherein said controller is configured to control said positioning in response to a detection signal from said detector.

4. The imager as claimed in claim 3, wherein said controller is configured to optimize one or more parameters of said detection signal.

5. The imager as claimed in claim 4, wherein said one or more parameters comprise a signal-to-noise ratio.

6. The imager as claimed in claim 1, wherein said scanning mirror comprises a resonance-type micro-mechanical mirror.

7. The imager as claimed in claim 1, wherein said imager is a time-of-flight scanning imager.

8. The imager as claimed in claim 1, wherein said actuator is configured and arranged to change an optical path length between said light source and said optical collimator.

9. The imager as claimed in claim 1, wherein said actuator is configured and arranged to move at least one of said light source and/or said optical collimator transversally to the optical path.

10. The imager as claimed in claim 1, wherein said actuator is configured and arranged to tilt at least one of said light source and/or said optical collimator relative to one another.

11. The imager as claimed in claim 1, wherein said actuator is configured and arranged to displace and/or to tilt said light detector.

12. The as claimed in claim 11, wherein said light detector comprises a position-sensitive light detector.

13. The imager as claimed in claim 1, wherein said collimator is configured to collimate said light beam in only one direction transversal to said beam direction in such a way as to generate a fan-shaped light beam with linear cross section, and wherein said scanning mirror is configured and arranged to sweep said fan-shaped light beam through said scene transversally to said linear cross section and illuminate slices of said scene.

14. The imager as claimed in claim 13, wherein said light detector is part of an imager chip with a linear photosensor array disposed with respect to said scanning mirror in such a way that the illuminated slices of the scene are successively imaged on said linear photosensor array.

15. Active-illumination scanning imager, comprising
a light source configured to produce a light beam,
an optical collimator configured to collimate said light beam in at least one direction transversal to a beam direction,
a scanning mirror configured to scan said light beam through a scene to be imaged a light detector arranged with respect to said scanning mirror in such a way as to receive a fraction of said light beam reflected from said scene, via said scanning mirror;
an actuator configured to position at least one of said light source and said optical collimator relative to one another;
and a controller operatively connected to said actuator so as to control said positioning, said light detector being operatively connected to said controller and said controller being configured to control said positioning in response to a detection signal from said detector.

16. Active-illumination scanning imager, comprising
a light source configured to produce a light beam,
an optical collimator configured to collimate said light beam in at least one direction transversal to a beam direction,
a scanning mirror configured to scan said light beam through a scene to be imaged
a light detector arranged with respect to said scanning mirror in such a way as to receive a fraction of said light beam reflected from said scene, via said scanning mirror;
an actuator configured to position said light detector relative to said scanning mirror;
and a controller operatively connected to said actuator so as to control said positioning, said light detector being operatively connected to said controller and said controller being configured to control said positioning in response to a detection signal from said detector.
